(19) United States
(12) Patent Application Publication
(10) Pub. No.: US 2011/0165050 A1
(43) Pub. Date: Jul. 7, 2011

(54) Sealing of no compressor and residaul gas expander in a nitric acid plant

(76) Inventors: Rainer Maurer, Schwelm (DE); Daniel Birke, Dortmund (DE); Egon Joachmann, Waltrop (DE)

(21) Appl. No.: 12/737,038

(22) PCT Filed: May 15, 2009
(86) PCT No.: PCT/EP2009/003471

§ 371 Date: Feb. 22, 2011

(30) Foreign Application Priority Data
Jun. 6, 2008 (DE) 102008027232.9

(51) Int. Cl. B01D 53/86; B01J 19/00

(52) U.S. Cl. 423/239.1; 422/198

(57) ABSTRACT

A process for sealing the NO compressor and the residual gas expander in a plant for the production of nitric acid by the dual-pressure process uses a low-pressure section, a NO compressor, a high-pressure section with oxidation and absorption, at least one heat exchanger, a residual gas expander, in which ammonia and compressed air are passed into the low-pressure section of the nitric acid plant, where ammonia is oxidised via a catalyst to yield NO and water. The obtained NO is partly oxidised to yield NO₂. The NO- and NO₂-saturated gas is passed into the NO compressor, the compressed NO- and NO₂-saturated gas is passed into the high-pressure section of the nitric acid plant where the residual NO is oxidised to yield NO₂, followed by absorption of nitrogen dioxide to nitric acid. The residual gas from the high-pressure section is routed to the residual gas expander via at least one heat exchanger. The shafts of the NO compressor are sealed by at least two sealing chambers against the gas-fed components and the shafts of the residual gas expander are sealed by means of at least two sealing chambers against the gas-fed components. All sealing chambers are provided with labyrinth seals, part of the residual gas is withdrawn downstream of the heat exchanger and subdivided into two partial flows, the first partial flow being passed into the respective first sealing chambers of the NO compressor, and the second partial flow being passed into the respective first sealing chambers of the residual gas expander, and the major part of the residual gas of the two partial flows reaches the gas-fed impeller through the labyrinth seal separating the gas-fed impeller from the first sealing chamber owing to the higher pressure level, and the residual gas escaping from the respective first sealing chamber into the respective second sealing chamber due to leaks in the labyrinth seals is passed into the off-gas flow of the residual gas expander.

The invention relates to a process as well as to the related device for sealing the NO compressor and the residual gas expander by means of residual gas in a plant for the production of nitric acid according to the dual-pressure process. A shaft with at least two sealing chambers, each being sealed by means of labyrinth seals, serves to seal the gas-fed ends of the NO compressor and the residual gas expander. Part of the residual gas is withdrawn downstream of the heat exchanger and subdivided into two partial flows, the first partial flow of which is passed into the first sealing chamber of the NO compressor and the second partial flow being passed into the first sealing chamber of the residual gas expander. Here, the major part of the residual gas of the two partial flows will reach the gas-fed impeller through the labyrinth seal separating the gas-fed impeller from the first sealing chamber owing to the higher pressure level. Due to leaks in the labyrinth seals, residual gas may escape from the first sealing chamber into the second sealing chamber. Escaping residual gas is passed into the off-gas flow of the residual gas expander.

Nitric acid is an essential feedstock in chemical industry applications and is used, for example, as a starting material in the production of fertilisers, explosives and for the nitrification of organic substances in the production of dyestuffs and disinfectants.

Since the beginning of the 20th century nitric acid has been produced by the so-called Ostwald process, which has been the main method for the commercial-scale industrial production ever since. This reaction is a catalytic oxidation of ammonia. The nitrogen monoxide obtained is converted to nitrogen dioxide which reacts with water to yield nitric acid which can be separated in trickle towers. This process is described in the publication “Inorganic nitrogen compounds” by Mundo/Weber, Carl Hanser Verlag Munchen Wien 1982, as well as in the patent document WO 01/68520 A1.

Nitric acid can be produced by the single-pressure or by the dual-pressure process. In the single-pressure process, the combustion as well as the absorption are both carried out at medium pressure (5 bar) or high pressure (>8 bar). The dual-pressure process according to the invention described herein differs from the single-pressure process in so far as the combustion takes place at medium pressure and the absorption at high pressure.

The dual-pressure process involves the advantage that the pressure levels are adapted to the respective reactions thus ensuring an optimum combustion yield as well as a compact absorption.

After the non-absorbed residual gas has passed through preheating sections, it is sent to a residual gas expander in order to expand it to ambient pressure and gain compression work. DE 102 07 627 A1 describes a process in which work is gained from residual gas expansion, for example, in which at least two expansion sections are used, wherein at least one heating device is arranged between the expansion sections for heating the previously expanded residual gas. The work gained from this is then used to drive one or more turbo-compressors.

According to the state of the art this process uses secondary air for sealing the NO compressor and the residual gas compressor in a plant for the production of nitric acid by the dual-pressure process. The secondary air is compressed air which is taken from the process air and cooled to the temperature required for sealing the machine by the aid of a heat exchanger.

The secondary air is passed onto non-wearing hydraulic shaft seals which require little maintenance. Mechanical seals or pumps without stuffing box, however, require more intensive filtering.

Frequently the differential pressure of the secondary air used for sealing the equipment is too low as compared to the inlet pressure of the NO gas, which makes it impossible to seal the equipment in a reliable manner. For this reason, instrument or plant air, for example, which corresponds to non-dried instrument air, is frequently used because of the higher pressure.

Also known is a compressor for nitrous gases which is provided with labyrinth seals as well as feed and discharge lines and mainly serves the purpose of dealing with the removal and prevention of crystalline salt deposits in compressors for nitrous gases by special injection of external water-vapour and thus achieving an adequate increase of the water-vapour pressure. The related process and device are described in DE 3014673 C2.

DE 3835341 A1 describes a centrifugal compressor with horizontal joint face for nitrous gases with labyrinth seals. It is the aim to ensure that identical pressures prevail in the annular spaces between the compression stages and to avoid flow passages of the medium to be compressed and thereby increase the operational reliability.

Another embodiment of a shaft seal for the reduction of leaks and for corrosion reduction in the case of a geared expander or a geared compressor is disclosed by DE 102005041003 A1. The shaft seal is especially characterised by the arrangement of the seal tips in three successive seal sections, the arrangement of an annular chamber between two seal sections each, the equipment of the annular chamber facing the interior space of the geared expander or compressor with a feeding device for a sealing gas, the pressure of which is higher than the pressure in the interior space of the geared expander or compressor, and the equipment of the annular chamber facing away from the interior space of the geared expander or compressor with a suction device for the sealing gas.

Further examples of shaft seals in compressors and expanders are given in GB 1582209 A and US 20050058533 A1. The latter refers to a dual labyrinth seal system which consists of two chambers nested into each other, the sealing effect being achieved by a high-pressure sealing medium which flows in opposite direction to possible leakage flows. In GB 1582209 compressed air is used as sealing medium in a compressor to avoid leakage flows of the main gas flow in the compressor between compressor wheel and stationary components of the compressor.

However, the mentioned embodiments do also not ensure optimum conditions for the necessary reliable sealing of the equipment.

It is therefore the aim of the invention to arrange for such sealing of the NO compressor and the residual gas expander in a plant for the production of nitric acid that reliable sealing of the equipment is ensured.

This is achieved by a process and a unit for sealing the NO compressor and the residual gas expander in a plant for the production of nitric acid by the dual-pressure process, including a low-pressure section, a NO compressor, a high-pressure section with oxidation and absorption, at least one heat exchanger and a residual gas expander. Ammonia and compressed air are passed into the low-pressure section of the nitric acid plant, where ammonia is oxidised via a catalyst to yield NO and water, the obtained NO is partly oxidised to yield NO₂ and the NO- and NO₂-saturated gas is passed into the NO compressor. The compressed NO- and NO₂-saturated gas is passed to the high-pressure section of the nitric acid plant where the residual NO is oxidised to yield NO₂, followed by absorption of nitrogen dioxide to nitric acid. The residual gas is routed to the residual gas expander via at least one heat exchanger. The shaft of the NO compressor is sealed by at least two sealing chambers against the gas-fed components and the shaft of the residual gas expander is sealed by means of at least two sealing chambers against the gas-fed components and all sealing chambers are provided with labyrinth seals and part of the residual gas is withdrawn downstream of the heat exchanger and subdivided into two partial flows, the first partial flow being passed into the first sealing chamber of the NO compressor and the second partial flow being passed into the first sealing chamber of the residual gas expander, the major part of the residual gas of the two partial flows reaches the gas-fed impeller through the labyrinth seal separating the gas-fed impeller from the first sealing chamber owing to the higher pressure level, and the residual gas escaping from the respective first sealing chamber into the respective second sealing chamber due to leaks in the labyrinth seals is passed into the off-gas flow of the residual gas expander.

In an embodiment of the process the residual gas required for the sealing chambers is withdrawn downstream of the heat exchanger from the residual gas line or from an intermediate section of the residual gas expander at the necessary temperature and the necessary gauge pressure.

1200 Nm³/h residual gas, for example, may be withdrawn downstream of the heat exchanger or from an intermediate section of the residual gas expander at a pressure of 3.3 bar g. These data refer to a plant capacity of 700-1500 tons per day, calculated for a 100% nitric acid.

Another embodiment of the process provides for the use of a third sealing chamber which serves to seal the NO compressor and/or the residual gas expander, which is operated with air as sealing gas and is of additional sealing effect.

The related device for sealing the NO compressor and the residual gas expander in a plant for the production of nitric acid by the dual-pressure process comprises a low-pressure section, a NO compressor, a high-pressure section, at least one heat exchanger, a residual gas expander, a device for feeding the NO gas obtained into the NO compressor, a feeding device by which the NO gas is introduced into the high-pressure section of the nitric acid plant, a device by which the residual gas is passed via a heat exchanger into the residual gas expander, a device for withdrawing and subdividing part of the residual gas into two partial flows, at least two sealing chambers on the shaft of the NO compressor, at least two sealing chambers on the shaft of the residual gas expander, feed flows of the two partial flows to the respective first sealing chambers of residual gas expander and NO compressor, labyrinth seals against their respective environments in all sealing chambers, wherein the respective first sealing chamber into which the residual gas is introduced is located in each case beside the impeller which is sealed by labyrinth seals and off-gas lines are provided from the second sealing chambers into the product gas flow of the residual gas expander.

In addition, the subject matter of the invention can be designed such that a third sealing chamber is provided for sealing the NO compressor and/or sealing the residual gas expander.

The invention is illustrated below in more detail in an exemplary fashion by means of two figures:

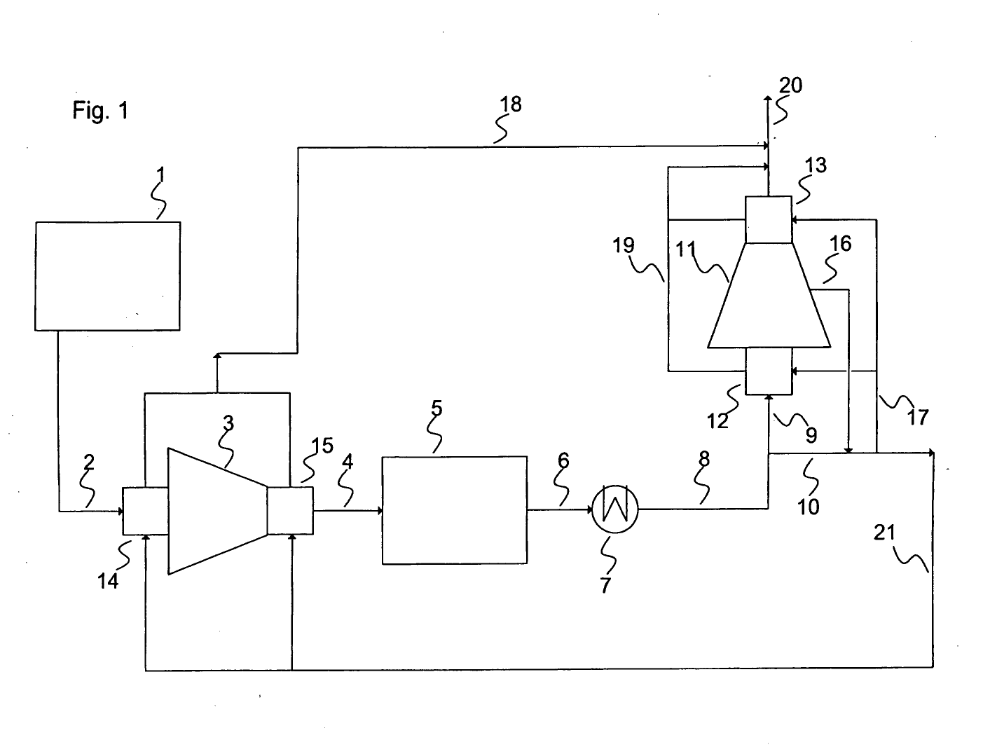

FIG. 1: Process flow diagram showing the process for the production of nitric acid according to the invention.

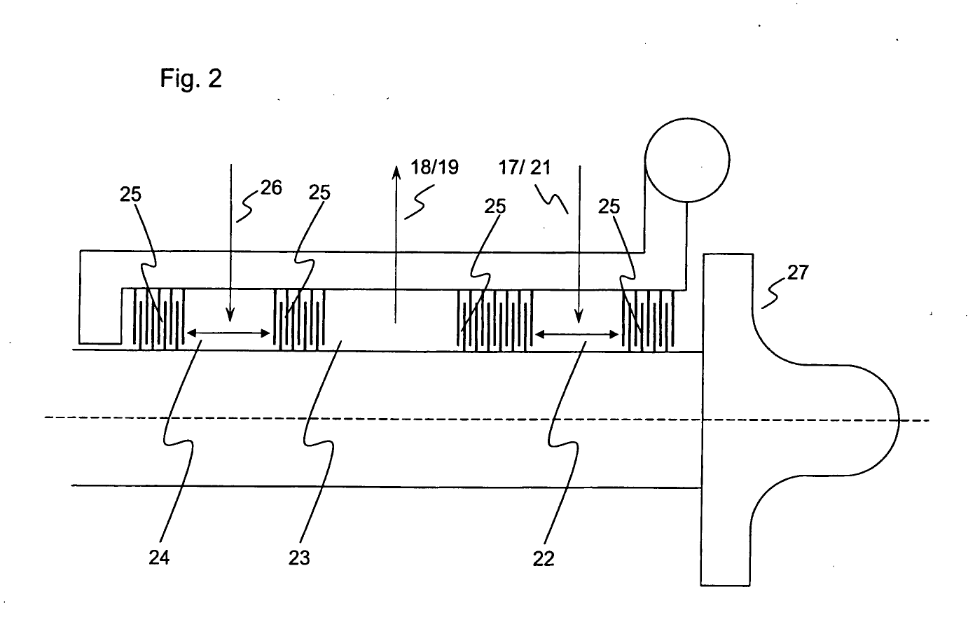

FIG. 2: Embodiment of the sealing chamber arrangement according to the invention.

FIG. 1 shows a low-pressure section (1) of a plant for the production of nitric acid in which ammonia is oxidised in the presence of a catalyst and air to yield NO and water, and the NO obtained is oxidised in part to yield NO₂. The resulting NO gas (2) is fed to a NO compressor (3) from where the compressed NO gas (4) is conveyed to the high-pressure section (5). Here, NO is oxidised to yield NO₂ and NO₂ is absorbed to give HNO₃. The residual gas obtained (6) is passed via a heat exchanger (7). The residual gas (8) from the heat exchanger (7) is subdivided into two partial flows of residual gas (9) and (10) before reaching the residual gas expander (11). Partial flow (9) is routed to the residual gas expander and partial flow (10) is again subdivided into two partial flows. The first partial flow (17) is directed to the respective first sealing chambers (22) of the gas-fed shafts (12, 13) of the residual gas expander (11), whereas the second partial flow (21), which has resulted from the subdivision of partial flow (10), is directed to the respective first sealing chambers (22) of the gas-fed shafts (14, 15) of the NO compressor (3). To subdivide the flow of residual gas into the two partial flows, the residual gas may alternatively be taken from an intermediate section (16) of the residual gas expander. The subdivision of the residual gas flow (16) results in the residual gas flow (21) which is routed to the respective first sealing chambers (22) of the gas-fed shafts (14, 15) of the NO compressor (3) as well as in the residual gas flow (17) which is directed to the first sealing chambers (22) of the gas-fed shafts (12, 13) of the residual gas expander (11). The residual gas (18) of the NO compressor (3) escaping by leaks from the respective first sealing chamber (22) into the respective second sealing chamber (23) is passed into the product flow (20) of off-gas expander (11) together with the residual gas (19) of the residual gas expander (11) escaping from the respectively first sealing chamber (22) into the respectively second sealing chamber (23).

FIG. 2 shows a shaft of the respectively gas-fed inlet or outlet of the NO compressor (14, 15) or the residual gas expander (12, 13) with three sealing chambers (22,23,24) in an exemplary fashion, each of which is sealed with labyrinth seals (25) against its environment. The residual gas consisting in partial flow (21) is passed into the respective first sealing chamber (22) of the NO compressor (3). The residual gas consisting in partial flow (17) is passed into the respective first sealing chamber (22) of the residual gas expander (11). Owing to the elevated pressure, the major part of the sealing gas flows through the labyrinth seal (25) installed between the impeller (27) and the respective first sealing chamber (22). A minor part of the sealing gas flows through the labyrinth seal (25) which spatially separates the first sealing chamber (22) from the second sealing chamber (23) and is discharged as off-gas flow (18 or 19). (18) represents the off-gas flow from the second sealing chamber of the NO compressor and (19) the off-gas flow from the second sealing chamber of the residual gas expander.

Further sealing effect is achieved by adding a third sealing chamber. This is also sealed against its environment by means of labyrinth seals and is operated by air.

Advantages involved in the invention:
the withdrawn residual gas is already of the temperature that is required for optimum sealing of the NO compressor and/or residual gas expander
the withdrawn residual gas is already of the pressure that is required for optimum sealing of the NO compressor and/or residual gas expander
by maintaining the optimum temperature and the optimum pressure of the residual gas which is used for sealing the equipment it is possible to ensure reliable sealing of the equipment
no additional gas needs to be fed in order to seal the equipment, which allows the plant to be operated economically.

### LIST OF REFERENCES USED

1 Low-pressure section
2 NO gas
3 NO compressor
4 Compressed NO gas
5 High-pressure section
6 Residual gas from the high-pressure section
7 Heat exchanger
8 Residual gas from the heat exchanger
9 Partial flow 1 from the heat exchanger
10 Partial flow 2 from the heat exchanger
11 Residual gas expander
12 Gas-fed shaft provided with sealing chambers at the inlet of the residual gas expander
13 Gas-fed shaft provided with sealing chambers at the outlet of the residual gas expander
14 Gas-fed shaft provided with sealing chambers at the inlet of the NO compressor
15 Gas-fed shaft provided with sealing chambers at the outlet of the NO compressor
16 Residual gas flow from an intermediate section of the residual gas expander
17 Partial flow from the subdivision of residual gas flow 10 or 16
18 Off-gas flow from the second sealing chamber of the NO compressor
19 Off-gas flow from the second sealing chamber of the residual gas expander
20 Off-gas flow from the residual gas expander
21 Partial flow from the subdivision of residual gas flow 10 or 16
22 First sealing chamber
23 Second sealing chamber
24 Third sealing chamber
25 Labyrinth seals
26 Air
27 Impeller

1-7. (canceled)

8. A process for sealing the NO compressor and the residual gas expander in a plant for the production of nitric acid by the dual-pressure process, the plant comprising:
a low-pressure section;
a NO compressor, the shaft of the NO compressor being sealed by at least two sealing chambers against the gas-fed components;
a high-pressure section with oxidation and absorption;
at least one heat exchanger;
a residual gas expander, the shaft of the residual gas expander being sealed by at least two sealing chambers against the gas-fed components;
all sealing chambers being provided with labyrinth seals;
the process comprising:
(a) passing ammonia and compressed air into the low-pressure section of the nitric acid plant, where ammonia is oxidised via a catalyst to yield NO and water;
(b) partly oxidising the obtained NO to yield NO₂;
(c) passing the obtained NO- and NO₂-saturated gas into the NO compressor;
(d) passing the compressed NO- and NO₂— gas to the high-pressure section of the nitric acid plant where the residual NO is oxidised to yield NO₂, followed by absorption of nitrogen dioxide to nitric acid; and
(e) routing the residual gas to the residual gas expander via at least one heat exchanger; wherein
the first sealing chamber is located in each case beside the gas-fed impeller of the compressor/expander;
part of the residual gas is withdrawn downstream of the heat exchanger and subdivided into two partial flows;
the first partial flow is passed into the first sealing chamber of the NO compressor; and
the second partial flow is passed into the first sealing chamber of the residual gas expander; and
the major part of the residual gas of the two partial flows reaches the gas-fed impeller through the labyrinth seal separating the gas-fed impeller from the first sealing chamber owing to the higher pressure level; and
the residual gas escaping from the respective first sealing chamber into the respective second sealing chamber due to leaks in the labyrinth seals is passed into the off-gas flow of the residual gas expander.

9. The process according to claim 8, wherein the residual gas required for the sealing chambers is withdrawn downstream of the heat exchanger from the residual gas line at the necessary temperature and the necessary gauge pressure

10. The process according to claim 8, wherein the residual gas required for the sealing chambers is withdrawn from an intermediate section of the residual gas expander at the necessary temperature and the necessary gauge pressure.

11. The process according to claim 8, wherein a third sealing chamber is provided for sealing the NO compressor and/or the residual gas expander, which is operated with air as sealing gas.

12. A plant for the production of nitric acid by the dual-pressure process, comprising:
a low-pressure section
a NO compressor, the shaft of the NO compressor being sealed by at least two sealing chambers against the gas-fed components and all sealing chambers being provided with labyrinth seals;
a high-pressure section;
at least one heat exchanger;
a residual gas expander, the shaft of the residual gas expander being sealed by at least two sealing chambers against the gas-fed components and all sealing chambers being provided with labyrinth seals;
a device for feeding the NO gas obtained into the NO compressor;
a feeding device by which the NO gas is introduced into the high-pressure section of the nitric acid plant;
a device by which the residual gas is passed via a heat exchanger into the residual gas expander;
a device for withdrawing and subdividing part of the residual gas into two partial flows;
feed flows of the two partial flows to the respective first sealing chambers of residual gas expander and NO compressor, wherein the respective first sealing chamber into which the residual gas is introduced is located in each case beside the impeller which is sealed by labyrinth seals; and
off-gas lines are provided from the second sealing chambers into the off-gas flow of the residual gas expander.

13. The device according to claim 12, wherein a third sealing chamber is provided for sealing the NO compressor.

14. The device according to claim 12, wherein a third sealing chamber is provided for sealing the residual gas expander.
